(19) United States
(12) Patent Application Publication
(10) Pub. No.: US 2004/0096573 A1
(43) Pub. Date: May 20, 2004

(54) System and method for vibration-assisted flow of encapsulating material in ignition coils

(76) Inventors: Larrie A. Davis, Mccordsville, IN (US); Gar P. Hoover, Anderson, IN (US)

Correspondence Address: MARGARET A. DOBROWITSKY, DELPHI TECHNOLOGIES, INC., Legal Staff, Mail Code: 480-410-202, P.O. Box 5052, Troy, MI, 48007-5052, US

(21) Appl. No.: 10/295,664

(22) Filed: Nov. 14, 2002

(51) Int. Cl. B05D 5/12; B05D 3/12; B05C 5/00; B05B 7/00

(52) U.S. Cl. 427/116; 427/346; 118/300; 118/663; 118/668

(57) ABSTRACT

Method and system for encapsulating a coil are provided. In one exemplary embodiment, the method allows providing a chamber for performing at least one manufacturing operation in connection with at least one coil to be encapsulated. The method further allows providing a pallet for supporting the at least one coil to be encapsulated. The pallet may be mounted on a conveyor configured to move the pallet in the chamber proximate to a nozzle configured to dispense encapsulant to the at least one coil. A vibration generator may be mechanically coupled to the conveyor. The vibration generator is electrically responsive to command signals from a controller. The command signals may be based on a vibration profile configured to controllably vibrate the at least one coil so that the encapsulant may flow assisted by the vibration through passages in the coil notwithstanding of a dimensional tightness of the passages therein, and thereby reduce the possibility of faults that could otherwise develop due to poor flow of the encapsulant.

### BACKGROUND OF THE INVENTION

The present invention is generally related to relatively high voltage coils, and, more particularly, the present invention is directed to system and method for vibration-assisted flow of encapsulating material in ignition coils.

Ignition coils (or pencil coils) for internal combustion engines may be configured to be directly coupled to spark plugs. Such ignition coils use both a primary coil and a secondary coil. The primary coil typically operates at a low voltage, while higher voltages are induced in the secondary coil.

In one common ignition coil design, it is known to use an appropriate thermosetting material, e.g., epoxy, for encapsulating purposes. That is, to fill with the appropriate encapsulating material respective channels or passageways defined by the primary and secondary coils. A problem may arise due to the relatively small clearance available for epoxy flow relative to the primary and secondary coils. For example, in a coil design having the secondary coil co-axially positioned relative to the primary coil, and a plastic case acting as a dielectric barrier between the secondary and the magnetic return path, the clearance for epoxy flow may be typically no more than approximately 0.3 to 0.5 mm. If one were to provide more room for epoxy flow, this would undesirably reduce the available volume of the coil for accommodating its operational components, such as the core, windings, and the shield.

Present techniques generally rely on gravity for introducing and passing the epoxy along the two channels defined by the primary and secondary coils. Even though the coils are generally encapsulated under vacuum, some residual air in the coil could get trapped and lead to voids (e.g., air bubbles) in the final product. These voids are particularly undesirable along the outer diameter (OD) of the secondary coil or in the secondary windings themselves. Positioning the coils at an angle with respect to the direction of flow of the epoxy to incrementally enhance the flow down one channel relative to the other channel may somewhat reduce the possibility of trapping air. However, this tilting technique does not consistently ensure that air will not be trapped and further this technique adds complexity and cost to the encapsulating equipment. U.S. patent application Ser. No. ______, (Attorney docket No. DP-308,241), commonly assigned to the same assignee of the present invention, in part, discloses a technique for pressurizing the encapsulating material being introduced for filling the channels of the ignition coil. This technique presupposes the availability of pressurization equipment as well as the availability of pressurizing air at the manufacturing site.

In view of the foregoing considerations, it would be desirable to provide ignition coil and techniques that at a low cost consistently facilitate the epoxy to flow in a manner that avoids or substantially reduces the formation of voids as the epoxy flows about the primary and secondary coils. It would be further desirable to integrate in field-deployed manufacturing equipment off-the-shelf and relatively inexpensive vibratory devices that would allow providing superior densification or compaction to the encapsulant material. It would be further desirable to provide techniques that do not rely on the availability of pressurization equipment and pressurized air in order to introduce the encapsulant.

### BRIEF SUMMARY OF THE INVENTION

Generally, the present invention fulfills the foregoing needs by providing in one aspect thereof, a method for encapsulating a coil. The method allows providing a chamber for performing at least one manufacturing operation in connection with at least one coil to be encapsulated. The method further allows providing a pallet for supporting the at least one coil to be encapsulated. The pallet may be mounted on a conveyor configured to move the pallet in the chamber proximate to a nozzle configured to dispense encapsulant to the at least one coil. A vibration generator may be mechanically coupled to the conveyor. The vibration generator is electrically responsive to command signals from a controller. The command signals may be based on a vibration profile configured to controllably vibrate the at least one coil so that the encapsulant may flow assisted by the vibration through passages in the coil notwithstanding of a dimensional tightness of the passages therein, and thereby reduce the possibility of faults that could otherwise develop due to poor flow of the encapsulant.

In another aspect thereof, the present invention further fulfills the foregoing needs by providing a method for encapsulating a coil. The method allows providing a chamber for performing at least one manufacturing operation in connection with at least one coil to be encapsulated. The method further allows providing a pallet for supporting the at least one coil to be encapsulated. A vibration generator is mechanically coupled to the exterior of the chamber. The vibration generator may be electrically responsive to command signals from a controller. The command signals may be based on a vibration profile configured to controllably vibrate the at least one coil so that the encapsulant may flow assisted by the vibration through passages in the coil notwithstanding of a dimensional tightness of the passages therein, and thereby reduce the possibility of faults that could otherwise develop in the coil due to poor flow of the encapsulant.

In another aspect of the invention, a system for encapsulating a coil is provided. The system may include a chamber for performing at least one manufacturing operation in connection with at least one coil to be encapsulated. The system may further include a pallet for supporting the at least one coil to be encapsulated. A conveyor is configured to move the pallet in the chamber proximate to a nozzle configured to dispense encapsulant to the at least one coil. A vibration generator, such as a variable speed motor, or electromagnetic vibrator, is mechanically coupled to the conveyor. A controller is configured to supply command signals to the vibration generator. The controller includes memory for storing a vibration profile for generating the command signals. The vibration profile is configured to controllably vibrate the at least one coil so that the encapsulant may flow assisted by the vibration through passages in the coil.

In yet another aspect thereof, the system may include a chamber for performing at least one manufacturing operation in connection with at least one coil to be encapsulated. The system may further include a pallet for supporting the at least one coil to be encapsulated. A vibration generator is mechanically coupled to the exterior of the chamber. A controller is configured to supply command signals to the vibration generator. The controller includes memory for storing a vibration profile for generating the command signals. The vibration profile is configured to controllably vibrate the at least one coil so that the encapsulant may flow assisted by the vibration through passages in the coil.

### BRIEF DESCRIPTION OF THE DRAWINGS

The features and advantages of the present invention will become apparent from the following detailed description of the invention when read with the accompanying drawings in which:

FIG. 1 is a cross-section of an exemplary ignition coil that may benefit from the teachings of the present invention regarding encapsulation system and techniques for vibration-assisted flow of encapsulating material through passages in the coil.

FIG. 2 is a schematic of an exemplary chamber including a vibration generator mechanically connected to a conveyor to impart vibration to one or more coils being encapsulated.

FIG. 3 is a schematic of the chamber of FIG. 2 wherein the vibration generator is connected to the exterior of the chamber.

FIG. 4 is a schematic of an oven including a vibration generator connected to the exterior of the chamber.

FIG. 5, made up of FIGS. 5A-5C, illustrates respective views of a table including a vibration generator for imparting vibration to coils mounted thereon.

### DETAILED DESCRIPTION OF THE INVENTION

The inventors of the present invention have innovatively recognized structure and techniques that are believed to improve the quality of ignition or pencil coils or any other relatively high voltage coil. More particularly, during an encapsulating operation, the present invention contemplates using an electric machine, such as a variable speed motor or electromagnetic vibrator, mechanically coupled to vibrate the ignition coil while coil channels therein are being filled, or upon such channels being filled, with the encapsulant.

FIG. 1 generally illustrates an exemplary ignition coil assembly 1 that may benefit from the teachings of the present invention. Exemplary structure for performing the actions discussed in the preceding paragraphs will be specifically discussed below. However, prior to such specific discussion a general discussion of the coil assembly 1 is deemed appropriate.

Referring to FIG. 1, ignition coil assembly 1 has a substantially rigid outer housing 2 at one end of which there may be appended a spark plug assembly (not shown). For readers desirous of further general background information regarding ignition coils reference is made to U.S. Pat. Nos. 6,276,348 and 6,232,863, each assigned in common to the same assignee of the present invention and herein incorporated by reference. Assembly 1 further includes a high voltage transformer including substantially coaxially arranged primary 10 and secondary 12 coil windings and a high permeability cylindrically shaped magnetic core 9.

A transformer portion is formed around a central magnetic core 9. For example, the magnetic core 9 may be manufactured from plastic coated iron particles in a compression molding operation. After the core 9 is molded, it is appropriately machined, such as by grinding, to provide a generally smooth surface free, for example, from sharp mold parting lines, which otherwise could be detrimental to the efficient operation of primary coil winding 10 thereon. Core 9 may also be formed of laminating structure, such as made up of thin silicon-steel plates of differing widths so that a cross-section thereof becomes substantially circular. Magnets having an appropriate polarity may be disposed respectively on both ends of iron core 9.

Primary coil 10 is wound directly on the cylindrical outer surface of core 9. The primary windings are typically formed from insulated wire, which are wound directly upon the outer cylindrical surface of the core 9. In some exemplary embodiments, the primary coil 10 may comprise two winding layers each in turn being comprised of from about 120 to 140 turns of No. 23 (or Nos. 21-25) AWG wire. In certain embodiments, voltages of from about 350 to 450 volts may be present in the primary coil 10, and the wire of that coil may have a diameter of from about 0.5 to 0.7 mm. Insulated copper wire may be utilized. The winding of the primary coil 10 being directly upon core 9 allows for efficient heat transfer of the primary resistive losses and improved magnetic coupling.

The primary sub-assembly may be inserted into the annulus spacing defined by cylindrical secondary spool 11. The secondary coil 12 is wound onto the outer surface of the secondary spool 11. The progressive windings of coil 12 may have from about 15,000 to 25,000 turns or wraps around the mid-section of secondary spool 11 to induce voltages higher than in the primary coil. The wire of the secondary coil may have a diameter of from about 0.05 to 0.07 mm in certain embodiments. Voltages of from about 8,000 to 40,000 volts may be induced in the secondary coil 12. By way of example, secondary spool 11 may be formed of an injection molded plastic insulating material having high temperature tolerance, such as a polybutylene terephthalate (PBT) thermoplastic polyester, LCP, or PPS.

As suggested above, in typical ignition coil designs, one may use an appropriate thermosetting material, e.g., epoxy, for encapsulating purposes. That is, to fill, with the appropriate encapsulating material, channels or passageways defined by the primary and secondary coils, such as channels 22 and 24. Since the clearance for epoxy flow in such channels may be relatively tight, typically no more than approximately 0.3 to 0.5 mm, aspects of the present invention are directed to improving the flow of the encapsulating material through such channels. Accordingly, vibratory devices are equipped onto equipment used to perform various processes associated with the fabrication of ignition coils. It is believed that vibration-assisted flow of encapsulating material through the coil channels would allow for providing superior densification or compaction to the encapsulant material.

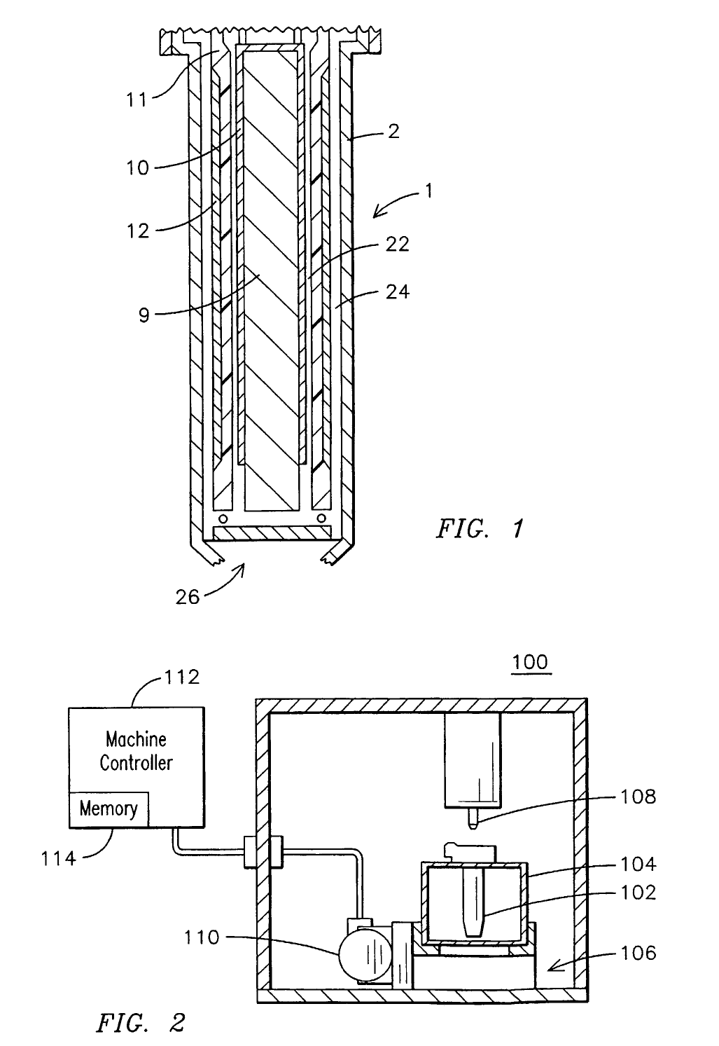

As shown in FIG. 2, in accordance with aspects of the present invention, a chamber 100, such as a casting chamber, is provided where at least one ignition coil 102, usually a plurality of coils, is supported on a pallet device or tray 104. The pallet in turn may be mounted on a conveyor 106 that allows to move the pallet device so that each ignition coil on the pallet may be eventually aligned relative to a nozzle 108 that dispenses encapsulating material to fill, for example, the first and second channels 22 and 24 (FIG. 1) of the ignition coil. In one aspect of the present invention, conveyor 106 is equipped to include a vibration generator 110, such as a variable speed induction motor, or an electromagnetic vibrator, responsive to command signals from a controller 112. In one advantageous aspect of the present invention, the vibration generator may comprise relatively inexpensive, off-the-shelf vibratory equipment such as may be commercially available from Cleveland Vibrator Company, Branford Vibrator Co., or any other purveyor of vibratory equipment. Another advantageous aspect of the present invention is not just the fact of using readily available vibratory equipment, but the ability to integrate at relatively low-cost such equipment into the various manufacturing devices that are already deployed in the various manufacturing operations of the assignee of the present invention. That is, the ability to provide an improvement to existing operations without having to disrupt such operations, or without having to undergo major expenditures of scarce capital resources.

In one exemplary embodiment, controller 112 includes memory 114 for storing an encapsulation profile, such as the amount of encapsulating material to be dispensed, the flow rate of the encapsulating material, environmental conditions of the casting chamber, e.g., temperature, barometric pressure, etc. More particularly, in accordance with aspects of the present invention, controller 112 is configured to provide the ability to controllably vibrate or shake the ignition coils so that the flow of encapsulant through any coil channels with relatively tight clearance may be more effectively accomplished.

As will be appreciated by those skilled in the art, the vibration from the vibration generator would be transferred through the conveyor to the coil and in turn to the coils being encapsulated. The encapsulation profile in memory 114 may be configured, either through analysis, experimentation and/or empirical data, to provide parameters for controlling the vibration during the encapsulation process, such as when to activate the vibration generator relative to the time when the encapsulant is introduced into the coil, for how long and at what level to activate the vibration generator. Thus, the encapsulation profile, for example, would allow controlling start time of the vibration generator, motor speed, and on time.

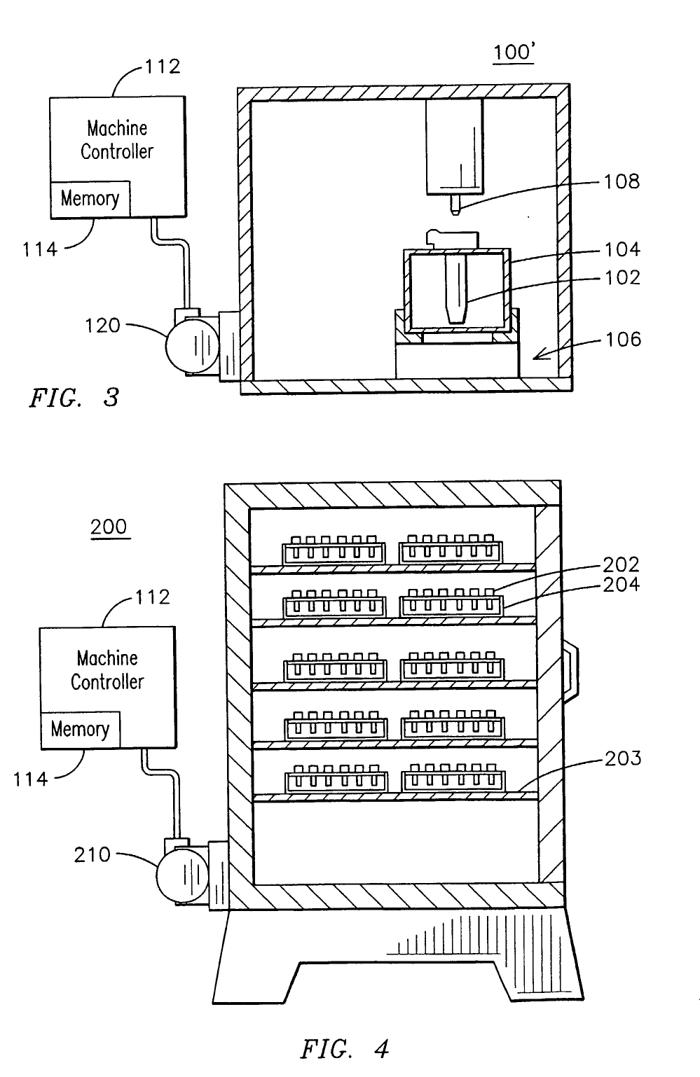

FIG. 3 illustrates an exemplary variation of the chamber 100 illustrated in FIG. 2. More particularly, FIG. 3 illustrates a casting chamber 100′ wherein a vibration generator 120 is directly coupled to the chamber in lieu of the conveyor. For example, this embodiment may be advantageously used in the event the interior of the casting chamber is not sufficiently spacious to accommodate the vibration generator. For example, in some applications, the interior of the casting chamber is just large enough to accommodate the pallet and the coils therein, and, therefore, in these situations using a vibration generator directly mounted to the exterior of the chamber would be desirable. It will be appreciated, however, that the vibration generator could be mounted onto the interior of the chamber, provided the chamber has sufficient space for accommodating the vibrator.

FIG. 4 illustrates another exemplary embodiment wherein a vibration generator 210 is externally mounted onto a chamber configured to function as an oven 200 including a plurality of shelves 203 for receiving a plurality of pallets 204. In this case, an encapsulation cure profile stored in memory 114 would provide suitable vibration parameters that may vary as a function of the encapsulation cure temperature. For example, the values of the duration and the level of vibration may vary based on the value of the oven temperature. Although FIG. 4 illustrates vibration generator 210 as externally mounted onto oven 200, it will be understood that the vibration generator may be mounted inside the oven. It will be further appreciated that in an automated encapsulation/cure process the casting chamber of FIG. 2 or 3 and the oven of FIG. 4 may be interconnected with one another through a suitable conveyor. Thus, in one exemplary embodiment, it is contemplated that the conveyor for moving the coils from the casting chamber to the oven may be equipped with a suitable vibration generator to shake the coils, as the coils travel on this interconnecting chamber. As used herein, the term “chamber” refers to enclosure and equipment for performing one or more manufacturing operations in connection with a workpiece (e.g., coil) to be encapsulated, such as a chamber for dispensing the encapsulant, or an oven for curing the encapsulant.

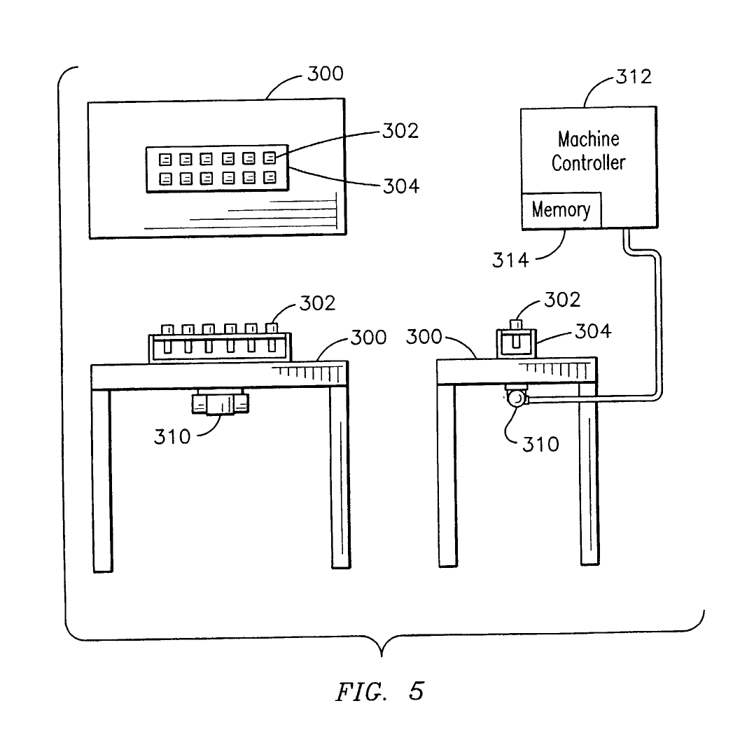

FIG. 5 illustrates yet another embodiment wherein a table 300 that supports one or more pallets 304 comprising a plurality of coils may be similarly equipped to include a vibration generator 310. For example, there may be situations where the flow of operations may impose restrictions as to the availability of a casting chamber or an oven. In this embodiment, it is contemplated that densification and compaction may be enhanced after the encapsulant has been introduced into the coil channels provided the encapsulant has not yet solidified. That is, densification and compaction may be facilitated by the vibration from vibration generator 310 provided the encapsulant is still in a liquified state. Thus, in one exemplary embodiment, it is contemplated that the table may comprise an intermediate station subsequent to the introduction of the encapsulant in the casting chamber and prior to curing in the oven.

In operation, aspects of the present invention allow vibrating the workpieces to achieve superior compaction and/or densification of the encapsulant material any time after, and/or during the time the encapsulating material is being dispensed into the workpiece.

By way of example and not of limitation, in an automated encapsulation and curing process the vibrator may be equipped:

Inside a casting chamber, optionally attached to a conveyor therein;

Outside the casting chamber attached onto the chamber;

Onto a conveyor interconnecting the casting chamber and an oven for curing;

Inside or outside the cure oven; or

Combinations of the above-listed arrangements for the vibrator.

By way of example and not of limitation, in a manual encapsulation and curing process the vibrator may be equipped:

Inside the casting chamber, optionally attached to the conveyor therein;

Outside the casting chamber attached onto the chamber;

Onto an intermediate vibration station, such as a table equipped with the vibrator, between the casting chamber and the oven;

Inside or outside the cure oven; or

Combinations of the above-listed arrangements for the vibrator.

It will be appreciated from the foregoing description that aspects of the present invention provide a low-cost, yet practical vibration means for reducing or eliminating voids near or within the coils and further provide enhanced winding impregnation. The vibration means may be chosen to be readily integrated with existing equipment, such as casting chamber, oven, etc. This results in avoiding the need of any large capital investment, as may be the case compared to systems that may require a costly separate and dedicated chamber with pressurization equipment and pressurized air.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A method for encapsulating a coil, the method comprising:
providing a chamber for performing at least one manufacturing operation in connection with at least one coil to be encapsulated;
providing a pallet for supporting the at least one coil to be encapsulated;
mounting the pallet on a conveyor configured to move the pallet in the chamber proximate to a nozzle configured to dispense encapsulant to the at least one coil; and
mechanically coupling a vibration generator to the conveyor, the vibration generator being electrically responsive to command signals from a controller, the command signals based on a vibration profile configured to controllably vibrate the at least one coil so that the encapsulant may flow assisted by the vibration through passages in the coil notwithstanding of a dimensional tightness of the passages therein, and thereby reduce the possibility of faults that could otherwise develop due to poor flow of the encapsulant.

2. The method of claim 1 wherein the vibration profile determines start time of a vibration event for the at least one coil being encapsulated.

3. The method of claim 1 wherein the vibration profile determines duration of the vibration event for the at least one coil being encapsulated.

4. The method of claim 1 wherein the vibration profile determines the level of vibration to be generated during the vibration event for the at least one coil being encapsulated.

5. A method for encapsulating a coil, the method comprising:
providing a chamber for performing at least one manufacturing operation in connection with at least one coil to be encapsulated;
providing a pallet for supporting the at least one coil to be encapsulated; and
mechanically coupling a vibration generator to the chamber, the vibration generator being electrically responsive to command signals from a controller, the command signals based on a vibration profile configured to controllably vibrate the at least one coil so that encapsulant may flow assisted by the vibration through passages in the coil notwithstanding of a dimensional tightness of the passages therein, and thereby reduce the possibility of faults that could otherwise develop in the coil due to poor flow of the encapsulant.

6. The method of claim 5 wherein the vibration profile determines start time of a vibration event for the at least one coil being encapsulated.

7. The method of claim 5 wherein the vibration profile determines duration of the vibration event for the at least one coil being encapsulated.

8. The method of claim 5 wherein the vibration profile determines the level of vibration to be generated during the vibration event for the at least one coil being encapsulated.

9. The method of claim 5 wherein the vibration generator is mechanically coupled to the exterior of the chamber.

10. The method of claim 5 wherein the vibration generator is mechanically coupled to the interior of the chamber.

11. The method of claim 5 wherein the chamber is equipped to dispense the encapsulant into the at least one coil.

12. The method of claim 5 wherein the chamber comprises an oven for curing encapsulant in the coil.

13. The method of claim 12 wherein the vibration profile is based, at least in part, on the cure temperature of the encapsulant.

14. A system for encapsulating a coil, the system comprising:
a chamber for performing at least one manufacturing operation in connection with at least one coil to be encapsulated;
a pallet for supporting the at least one coil to be encapsulated;
a conveyor configured to move the pallet in the chamber proximate to a nozzle configured to dispense encapsulant to the at least one coil;
a vibration generator mechanically coupled to the conveyor; and
a controller configured to supply command signals to the vibration generator, the controller including memory for storing a vibration profile for generating the command signals, the vibration profile configured to controllably vibrate the at least one coil so that the encapsulant may flow assisted by the vibration through passages in the coil.

15. The system of claim 14 wherein the vibration profile determines start time of a vibration event for the at least one coil being encapsulated.

16. The system of claim 14 wherein the vibration profile determines duration of the vibration event for the at least one coil being encapsulated.

17. The system of claim 14 wherein the vibration profile determines the level of vibration to be generated during the vibration event for the at least one coil being encapsulated.

18. The system of claim 14 wherein the vibration generator comprises a variable speed motor.

19. The system of claim 14 wherein the vibration generator comprises an electromagnetic vibrator.

20. A system for encapsulating a coil, the system comprising:
a chamber for performing at least one manufacturing operation in connection with at least one coil to be encapsulated;
a pallet for supporting the at least one coil to be encapsulated;
a vibration generator mechanically coupled to the chamber; and
a controller configured to supply command signals to the vibration generator, the controller including memory for storing a vibration profile for generating the command signals, the vibration profile configured to controllably vibrate the at least one coil so that the encapsulant may flow assisted by the vibration through passages in the coil.

21. The system of claim 20 wherein the vibration profile determines start time of a vibration event for the at least one coil being encapsulated.

22. The system of claim 20 wherein the vibration profile determines duration of the vibration event for the at least one coil being encapsulated.

23. The system of claim 20 wherein the vibration profile determines the level of vibration to be generated during the vibration event for the at least one coil being encapsulated.

24. The system of claim 20 wherein the vibration generator comprises a variable speed motor.

25. The system of claim 20 wherein the vibration generator comprises an electromagnetic vibrator.

26. The system of claim 20 wherein the vibration generator is mechanically coupled to the exterior of the chamber.

27. The system of claim 20 wherein the vibration generator is mechanically coupled to the interior of the chamber.

28. The system of claim 20 wherein the chamber is equipped to dispense the encapsulant into the at least one coil.

29. The system of claim 20 wherein the chamber comprises an oven for curing encapsulant in the coil.

30. The method of claim 29 wherein the vibration profile is based, at least in part, on the cure temperature of the encapsulant.

31. A method for encapsulating a coil, the method comprising:
providing a chamber equipped to dispense encapsulant in at least one coil;
providing a pallet for supporting the at least one coil to be encapsulated;
providing an oven for curing encapsulant dispensed in the at least one coil; and
mechanically coupling a vibration generator to at least one of the chamber and the oven, the vibration generator being electrically responsive to command signals from a controller, the command signals based on a vibration profile configured to controllably vibrate the at least one coil so that encapsulant may flow assisted by the vibration through passages in the coil notwithstanding of a dimensional tightness of the passages therein, and thereby reduce the possibility of faults that could otherwise develop in the coil due to poor flow of the encapsulant.

32. The method of claim 31 further comprising providing a conveyor for transferring the pallet from the chamber to the oven, wherein the conveyor is equipped with a vibration generator electrically responsive to command signals from the controller to controllably vibrate the at least one coil as the coil is transferred from the chamber to the oven.

33. The method of claim 32 wherein the transferring of the pallet from the chamber to the oven comprises an automated transfer.

34. The method of claim 31 further comprising providing a table equipped with a vibration generator electrically responsive to command signals from a controller to controllably vibrate the at least one coil as the pallet is placed on the table and awaits transfer to the oven.

35. The method of claim 34 further comprising transferring the pallet to the oven upon completing vibration of the at least one coil on the table, and wherein the transfer from the chamber to the oven comprises a non-automated transfer.

36. A method for encapsulating a coil, the method comprising:
providing a chamber equipped to dispense encapsulant in at least one coil;
providing a pallet for supporting the at least one coil to be encapsulated;
providing an oven for curing encapsulant dispensed in the at least one coil; and
providing a conveyor for transferring the pallet from the chamber to the oven, wherein the conveyor is equipped with a vibration generator electrically responsive to command signals from a controller to controllably vibrate the at least one coil as the pallet with the coil is transferred from the chamber to the oven.

37. A method for encapsulating a coil, the method comprising:
providing a chamber equipped to dispense encapsulant in at least one coil;
providing a pallet for supporting the at least one coil to be encapsulated;
providing an oven for curing encapsulant dispensed in the at least one coil;
removing the pallet from the chamber upon completion of the dispensing of encapsulant in the at least one coil;
providing a table equipped with a vibration generator, the table being external from the chamber; and
placing the pallet with the at least one coil on the table equipped with the vibration generator, wherein the vibration generator is electrically responsive to command signals from a controller to controllably vibrate the at least one coil as the pallet placed on the table awaits transfer to the oven.
